(19) United States
(12) Patent Application Publication
(10) Pub. No.: US 2013/0050034 A1
(43) Pub. Date: Feb. 28, 2013

(54) AUTOMOTIVE RADAR DEVICE AND ANTENNA COVER THEREOF

(71) Applicants: Yi-Cheng Wu, Hsinchu (TW); Yi-Jie Wang, Hsinchu (TW); Chao-Chun Lin, Hsinchu (TW); Cheng-Hsiung Hsu, Hsinchu (TW); I-Shan Chen, Hsinchu (TW); Ta-Wei Hsu, Hsinchu (TW)

(72) Inventors: Yi-Cheng Wu, Hsinchu (TW); Yi-Jie Wang, Hsinchu (TW); Chao-Chun Lin, Hsinchu (TW); Cheng-Hsiung Hsu, Hsinchu (TW); I-Shan Chen, Hsinchu (TW); Ta-Wei Hsu, Hsinchu (TW)

(21) Appl. No.: 13/253,975

(22) Filed: Oct. 6, 2011

(30) Foreign Application Priority Data
Aug. 26, 2011 (TW) 100130717

(51) Int. Cl. H01Q 1/32; H01Q 1/42

(52) U.S. Cl. 343/713; 343/872

(57) ABSTRACT

An automotive radar device and an antenna cover are disclosed. The automotive radar device includes a base, an antenna disposed on the base, and the antenna cover. The antenna cover includes a main portion and an engagement portion connected to the circumference of the main portion. The engagement portion can be engaged to the base such that the main portion covers the antenna. Therein, a thickness of the main portion along a radiation direction of the antenna is equal to half-wavelength corresponding to a center operation frequency of the antenna under a dielectric constant of the main portion. Thereby, energy radiated from the antenna can mostly pass through the main portion without excessive signal attenuation, which solves the insufficient signal intensity due to a protection cover in the prior art. Further, the main portion can be made of flexible and weather resistant material to improve its physical and chemical properties.

### BACKGROUND OF THE INVENTION

1. Field of the Invention

The invention relates to an antenna cover and an automotive radar device, and especially relates to an antenna cover with high penetrability and an automotive radar device having the antenna cover.

2. Description of the Prior Art

In order to improve driving safety, some automobiles have been equipped with automotive radar devices disposed in their rear bumpers for detecting the traffic situation behind the automobiles. For enhancing the efficiency of detecting blind spots, the automotive radar device is usually exposed out, so the automotive radar device needs an antenna cover to protect a physical antenna. A current antenna cover is usually made of composite material consisting of polytetrafluornethylene (PTFE) and glass fiber. The practical application environment for the antenna cover is hard, such as weather influence, impact by sandstone on the ground and so on, so the antenna cover tends to be aged, deformed, or stress cracked to be damaged and the protection function thereof is therefore reduced, even lost. Furthermore, because most of current automotive radar devices are designed to be of low power consumption and low transmission loss, the structure of the antenna cover will influence the signal transmission loss. Besides, when the antenna cover varies in material and deforms in structure, the signal transmission loss becomes worse and the detection efficiency is therefore influenced.

### SUMMARY OF THE INVENTION

An objective of the invention is to provide an antenna cover for an automotive radar device. The antenna cover can reduce signal transmission loss through designing its structural thickness and can further enhance its structural strength and weather resistance through choosing proper formation material.

The antenna cover of the invention is used in an automotive radar device. The automotive radar device includes a base and an antenna disposed on the base. The antenna has a center operation frequency. The antenna cover includes a main portion and an engagement portion. The main portion has a dielectric constant. The engagement portion is connected to the circumference of the main portion. The engagement portion is capable of being engaged to the base such that the main portion covers the antenna. The thickness of the main portion along the radiation direction of the antenna is equal to half-wavelength corresponding to the center operation frequency under the dielectric constant. Thereby, the antenna cover has a quite low transmission loss; that is, the loss of the wireless electromagnetic wave passing through the antenna cover can be reduced efficiently, which is conducive to the blind spot detection efficiency.

Further, the main portion can be made of a flexible composite material such as a composite consisting mainly of polybutylene terephthalate (PBT) and glass fiber or a composite consisting mainly of polycarbonate (PC), PBT, and glass fiber, so as to enhance the structural strength and weather resistance of the antenna cover.

Another objective of the invention is to provide an automotive radar device having the antenna cover of the invention. Therefore, the automotive radar device also has the functions of reducing signal transmission loss and enhancing the structural strength and weather resistance of the antenna cover.

The automotive radar device of the invention includes a base, an antenna, and an antenna cover. The antenna is disposed on the base and has a center operation frequency. The antenna cover includes a main portion and an engagement portion. The main portion has a dielectric constant. The engagement portion is connected to the circumference of the main portion. The engagement portion is capable of being engaged to the base such that the main portion covers the antenna. The thickness of the main portion along the radiation direction of the antenna is equal to half-wavelength corresponding to the center operation frequency under the dielectric constant. Similarly, the antenna cover has a quite low transmission loss; that is, the loss of the wireless electromagnetic wave passing through the antenna cover can be reduced efficiently, which is conducive to the blind spot detection efficiency.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an automotive radar device of a preferred embodiment according to the present invention.

FIG. 2 is a schematic diagram illustrating the automotive radar device in FIG. 1 which is partially exploded.

FIG. 3 is a sectional view of the antenna cover in FIG. 1.

FIG. 4 is a top view of an antenna cover whose main portion has a circular profile.

FIG. 5 is a top view of an antenna cover whose main portion has a hexagonal profile.

FIG. 6 is a top view of an antenna cover whose main portion has a polygonal profile.

FIG. 7 is a schematic diagram illustrating the position where the automotive radar device is disposed on an automobile.

FIG. 8 is a sectional view of the automotive radar device integrated with a bumper (or a sheet metal part) of the automobile in FIG. 7.

FIG. 9 is a sectional view of the automotive radar device integrated with a bumper (or a sheet metal part) of the automobile in FIG. 7 according to another embodiment.

### DETAILED DESCRIPTION

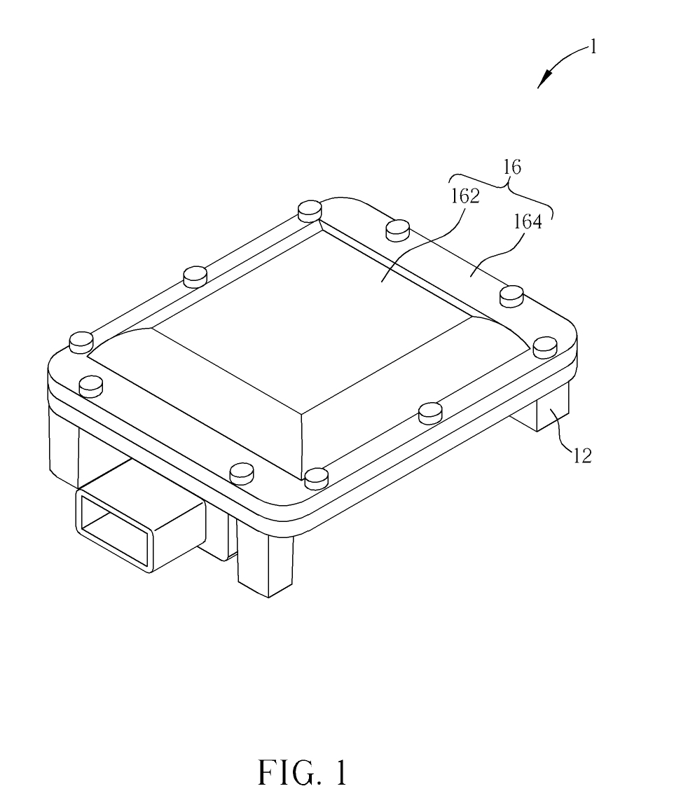

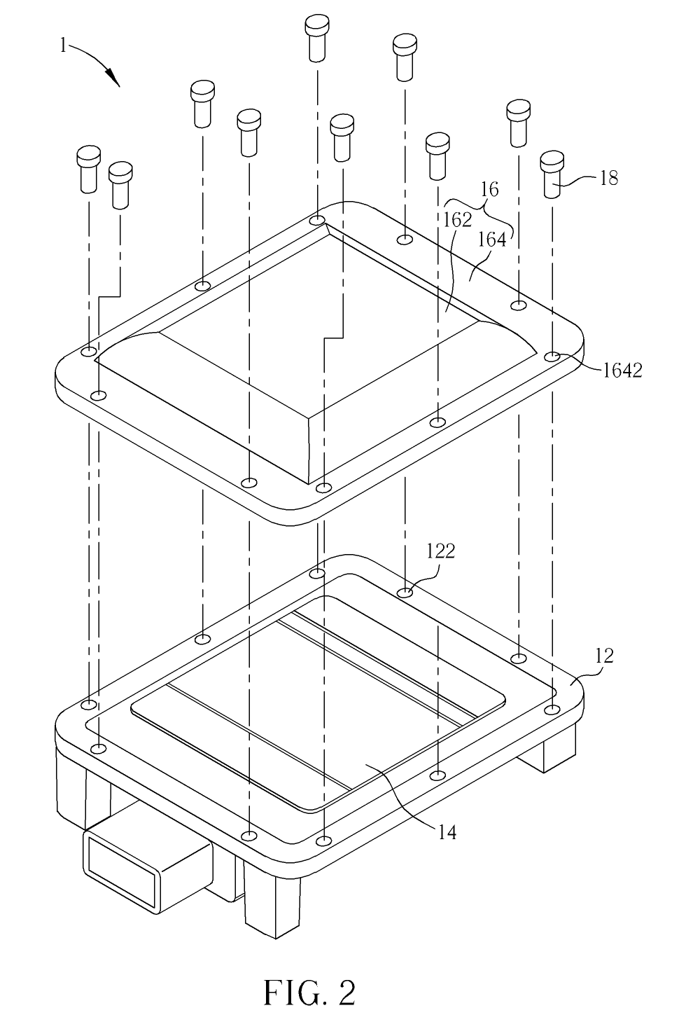

Please refer to FIG. 1 and FIG. 2. FIG. 1 is a schematic diagram illustrating an automotive radar device 1 of a preferred embodiment according to the present invention. FIG. 2 is a schematic diagram illustrating the automotive radar device 1 partially exploded. The automotive radar device 1 includes a base 12, an antenna 14, and an antenna cover 16. The antenna 14 is disposed on the base 12 and has a center operation frequency. The antenna cover 16 includes a main portion 162 and an engagement portion 164. The main portion 162 has a dielectric constant. The engagement portion 164 is connected to the circumference of the main portion 162. The engagement portion 164 is capable of being engaged to the base 12 such that the main portion 162 covers the antenna 14 so as to accomplish the purpose of protecting the antenna 14. In the embodiment, the engagement portion 164 thereon forms a plurality of through holes 1642; the base 12 thereon forms a plurality of threaded holes 122 corresponding to the through holes 1642. The engagement portion 164 is mounted on the base 12 by a plurality of screws 18 passing through the through holes 1642 and being screwed into the threaded holes 122. In practice, the engagement portion 164 can be engaged to the base 12 in other ways, for example by adhering or a hook mechanism; however, the invention is not limited to it.

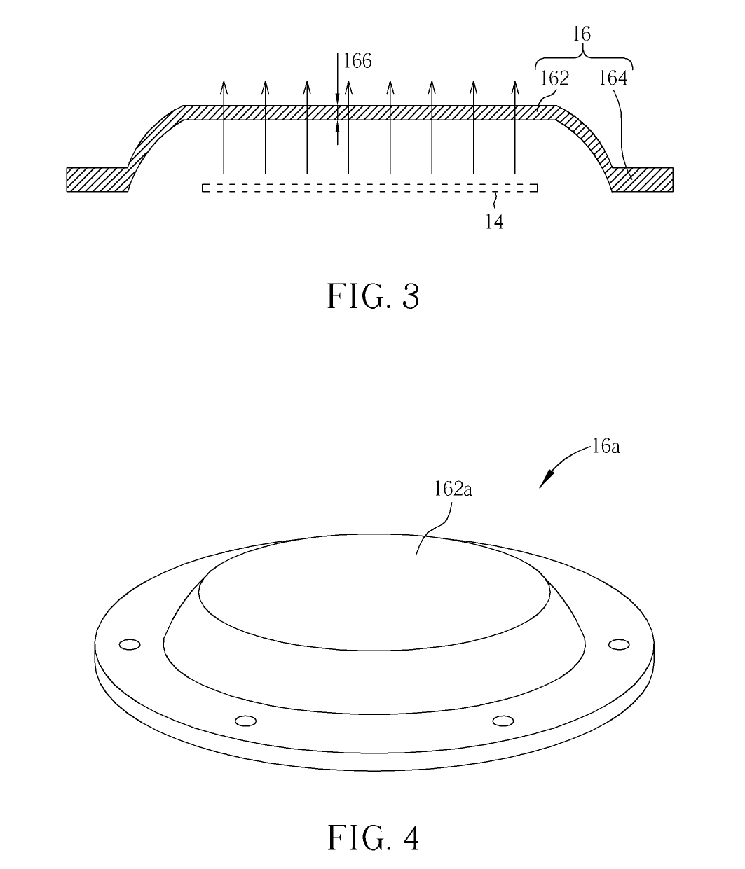

Please also refer to FIG. 3. FIG. 3 is a sectional view of the antenna cover 16; therein, the antenna 14 is shown by dashed lines to show its position relative to the antenna cover 16. In the embodiment, the antenna 14 is a flat plate antenna. The radiation direction of its wireless electromagnetic wave is indicated by arrows. The thickness 166 of the main portion 162 along the radiation direction of the antenna 14 is equal to half-wavelength corresponding to the center operation frequency under the dielectric constant. For example, the center operation frequency is 24 GHz; the dielectric constant is 3.8; then the thickness 166 is about 3.3±0.5 mm. For another example, the center operation frequency is 77 GHz; the dielectric constant is 3.8; then the thickness 166 is about 1.0±0.3 mm. But the invention is not limited to these. It is added that in the embodiment, the antenna 14 is tabular, so the main portion 162 is a late structure. Therefore, if the radiation direction of the antenna 14 shows a spherical radiation, the main portion 162 will be formed to be a spherical shell structure correspondingly such that the electrical path length passing through the main portion 162 of the wireless electromagnetic wave is half-wavelength. In sum, the geometric structure of the main portion 162 is designed to match the radiation field of the antenna 14 such that the electrical path length passing through the main portion 162 of the wireless electromagnetic wave is half-wavelength, so as to reduce the signal transmission loss of the wireless electromagnetic wave efficiently.

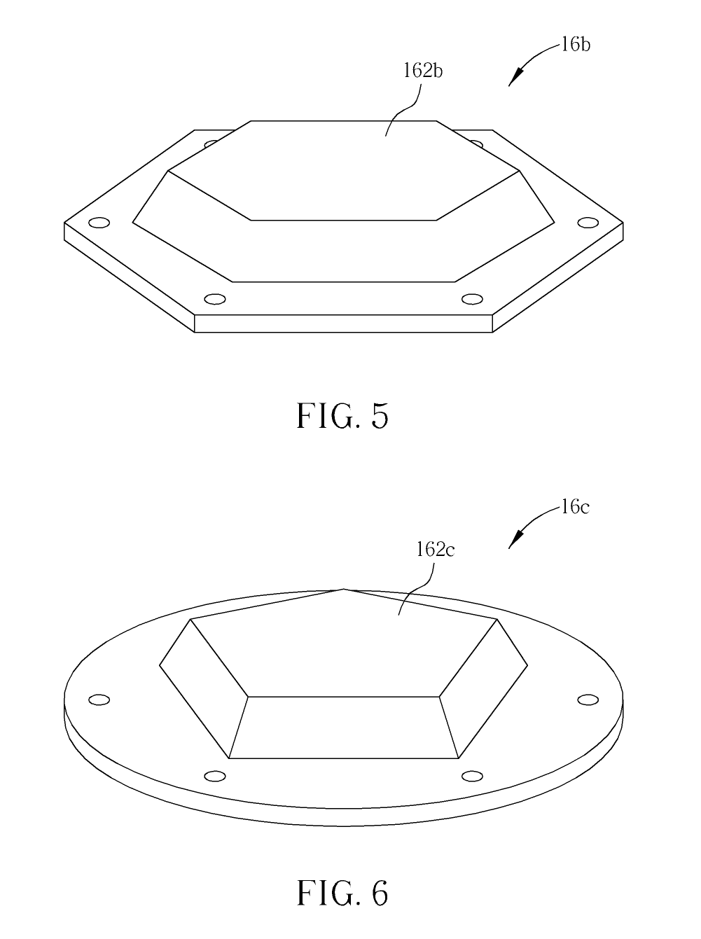

In addition, in the embodiment, the main portion 162 has a rectangular profile, but the invention is not limited to it. In practice, the main portion 162 can be formed with a different geometric profile matching with the profile of the antenna 14 or matching with the engagement structure of the engagement portion 164 and the base 12. For example, the main portion 162a of the antenna cover 16a shown in FIG. 4 has a circular profile; the main portion 162b of the antenna cover 16b shown in FIG. 5 has a hexagonal profile; the main portion 162c of the antenna cover 16c shown in FIG. 6 has a polygonal profile. Therein, the profile of the engagement portion of each of the antenna covers is unnecessarily similar to the profile of the main portion. For example, the profile of the engagement portion of the antenna cover 16c is circular.

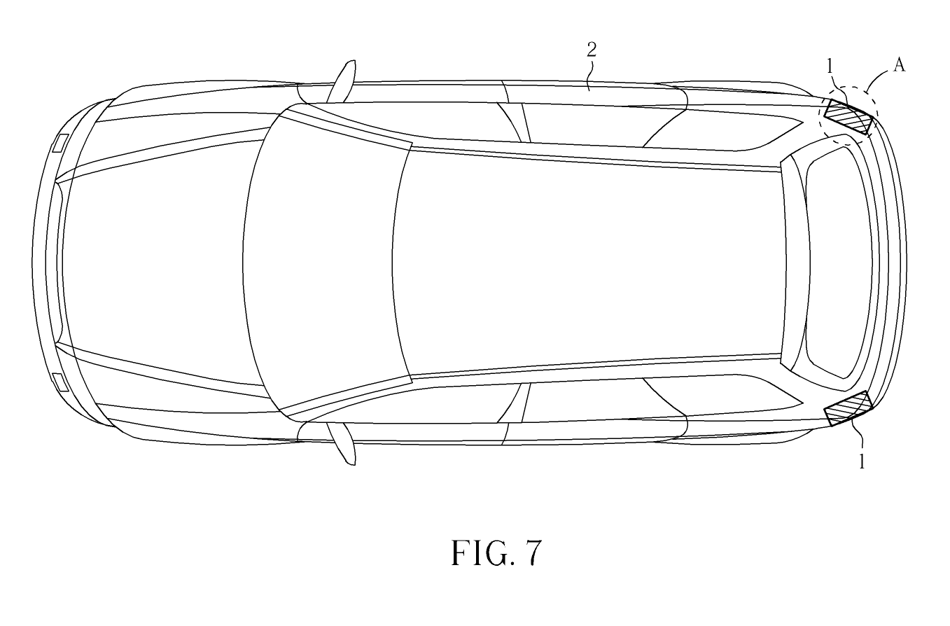

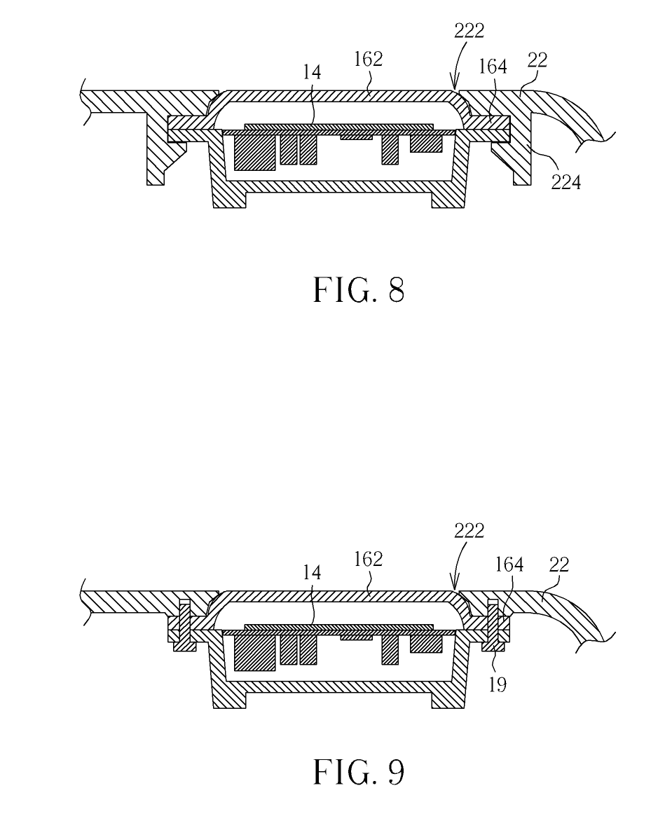

Please refer to FIG. 7 and FIG. 8. FIG. 7 is a schematic diagram illustrating the position where the automotive radar device 1 is disposed on an automobile 2; therein, the automotive radar device 1 is shown by a hatched rectangle. FIG. 8 is a sectional view of the automotive radar device 1 integrated with a bumper 22 (or a sheet metal part) of the automobile 2; the position thereof is shown as the circle A in FIG. 7. As shown in FIG. 7, the automotive radar device 1 is disposed at a corner of the rear of the automobile 2, so it can detect blind spots of a driver efficiently. In order to reduce the signal loss of the automotive radar device 1, the bumper 22 (or the sheet metal part) thereon forms a window 222 and an engagement structure 224. The automotive radar device 1 is engaged with the engagement structure 224 from the inside of the bumper 22 (or the sheet metal part) such that the main portion 162 is exposed through the window 222. Thereby, the wireless electromagnetic wave emitted from or received by the antenna 14 passes through only the main portion 162, which avoids unnecessary signal loss. In practice, the exposed main portion 162 can be integrated with the bumper 22 (or the sheet metal part) in structure surface so as to keep the appearance of the automobile 2 smooth. In addition, the engagement structure 224 is taken as an example for illustrating the engagement of the automotive radar device 1 and the automobile 2, but the invention is not limited to it. For another example as shown in FIG. 9, the automotive radar device 1 is mounted directly on the bumper 22 (or the sheet metal part) by screws 19, which also achieves the purpose of integration and fixation.

According to the illustration of the above embodiment, the main portion 162 of the automotive radar device 1 is exposed and is disposed relatively closer to the ground, so the main portion 162 is affected by the environment very easily, such as rain, ground water, impact by sandstone, exposure to the sunshine and so on. Therefore, in practice, the antenna cover 16 is made in one piece. The material of the antenna cover 16 can be flexible and weather resistant material. For example, the main portion 162 can be made of the flexible composite material of PBT and glass fiber. The glass fiber ranges between 10 to 30 percent by weight, and the remainder of the flexible composite material is the PBT. The addition of the glass fiber can improve the structural strength of the main portion 162 and also can avoid excessive shrinkage of the main portion 162 after forming influencing the thickness uniformity of the main portion 162.

In addition, because the crystallization temperature of PBT is relatively low, if the main portion 162 has a plate or shell structure with a larger length-to-thickness ratio, short molding occurs easily. Therefore, in practice, the one-piece antenna cover 16 can be made of the flexible composite material of PBT, PC, and glass fiber. The glass fiber ranges between 10 to 30 percent by weight, the PC ranges between 30 to 50 percent by weight, and the remainder of the flexible composite material is the PBT. The addition of the PC can reduce the degree of crystallization of the PBT so that the molding solution can fill up all portions of the antenna cover 16 uniformly before being solidified so as to achieve the result of uniform thickness. Besides, the PC can improve the impact resistance of the antenna cover 16. It is added that the solution according to the invention for molding the antenna cover 16 is not limited to the above; in principle, any solution with weather resistance, flexibility, and capability of improving the strength can be used to form the antenna cover of the invention.

As discussed above, the invention controls the thickness of the antenna cover for the automotive radar device so that the wireless electromagnetic wave emitted by the antenna can pass through the main portion in a quite low loss and the loss of the wireless electromagnetic wave reflected from the outside also can be reduced efficiently. Furthermore, the antenna cover can be made of flexible and weather resistant material for improving the mechanical property and weather resistance thereof and further for enhancing the resistance to physical or chemical damage from the outside. In addition, in practice, the antenna cover can be structurally integrated with the bumper or the sheet metal part of the automobile, so that the main portion can be exposed, the appearance of the automobile can be preserved, and the wireless electromagnetic wave emitted from or received by the antenna can be prevented from inducing unnecessary signal loss due to passing through other objects. Therefore, compared to the prior art, the antenna cover and the automotive radar device of the invention can reduce the transmission loss of the wireless electromagnetic wave efficiently, which is conducive to the blind spot detection efficiency; besides, the service life of the antenna cover of the invention can be extended so as not to increase the transmission loss due to material defects induced by a long use.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An antenna cover for an automotive radar device, the automotive radar device comprising abase and an antenna disposed on the base, the antenna has a center operation frequency, the antenna cover comprising:
a main portion, having a dielectric constant; and
an engagement portion, connected to a circumference of the main portion, the engagement portion being capable of being engaged to the base such that the main portion covers the antenna, a thickness of the main portion along a radiation direction of the antenna being equal to half-wavelength corresponding to the center operation frequency under the dielectric constant.

2. The antenna cover of claim 1, wherein the main portion is made of a flexible composite material.

3. The antenna cover of claim 2, wherein the flexible composite material comprises polybutylene terephthalate (PBT) and glass fiber.

4. The antenna cover of claim 3, wherein the glass fiber ranges between 10 to 30 percent by weight, and the remainder of the flexible composite material is the PBT.

5. The antenna cover of claim 2, wherein the flexible composite material comprises PBT, polycarbonate (PC), and glass fiber.

6. The antenna cover of claim 5, wherein the glass fiber ranges between 10 to 30 percent by weight, the PC ranges between 30 to 50 percent by weight, and the remainder of the flexible composite material is the PBT.

7. The antenna cover of claim 1, wherein the main portion has a rectangular profile, a circular profile, a hexagonal profile, or a polygonal profile.

8. An automotive radar device, comprising:
a base;
an antenna, disposed on the base, the antenna having a center operation frequency; and
an antenna cover, comprising:
a main portion, having a dielectric constant; and
an engagement portion, connected to a circumference of the main portion, the engagement portion being capable of being engaged to the base such that the main portion covers the antenna, a thickness of the main portion along a radiation direction of the antenna being equal to half-wavelength corresponding to the center operation frequency under the dielectric constant.

9. The automotive radar device of claim 8, wherein the main portion is made of a flexible composite material.

10. The automotive radar device of claim 9, wherein the flexible composite material comprises PBT and glass fiber.

11. The automotive radar device of claim 10, wherein the glass fiber ranges between 10 to 30 percent by weight, and the remainder of the flexible composite material is the PBT.

12. The automotive radar device of claim 9, wherein the flexible composite material comprises PBT, PC, and glass fiber.

13. The automotive radar device of claim 12, wherein the glass fiber ranges between 10 to 30 percent by weight, the PC ranges between 30 to 50 percent by weight, and the remainder of the flexible composite material is the PBT.

14. The automotive radar device of claim 8, wherein the main portion has a rectangular profile, a circular profile, a hexagonal profile, or a polygonal profile.

15. The automotive radar device of claim 8, wherein the antenna is a flat plate antenna, and the main portion is a plate structure.

16. The automotive radar device of claim 8, wherein the automotive radar device is capable of being engaged to a bumper or a sheet metal part of an automobile through the engagement portion such that the main portion is exposed through a window of the bumper or the sheet metal part.
